(19) United States
(12) Patent Application Publication
(10) Pub. No.: US 2026/0356171 A1
(43) Pub. Date: Nov. 12, 2026

(54) AIR-CONDITIONING REGISTER

(71) Applicant: TOYODA GOSEI CO., LTD., Kiyosu-shi (JP)

(72) Inventor: Hironori TAKAGI, Kiyosu-shi (JP)

(21) Appl. No.: 19/641,723

(22) Filed: Apr. 8, 2026

(30) Foreign Application Priority Data
May 9, 2025 (JP) 2025-078687

(51) Int. Cl. B60H 1/34

(52) U.S. Cl. CPC B60H 1/3421

(57) ABSTRACT

An air-conditioning register includes a case body, an inner member, a passage for conditioned air, and an air outlet. The case body includes first and second walls facing each other. Of the case body, the inner member is in contact with only the second wall. The inner member protrudes from the second wall toward the first wall. When a direction orthogonal to a direction in which the passage extends and a protruding direction of the inner member is defined as an orthogonal direction, two body passage portions forming part of the passage are provided on opposite sides of the inner member in the orthogonal direction in the case body, respectively, and a connecting passage portion that forms part of the passage and connects the two body passage portions to each other is provided between a protruding end surface of the inner member in the protruding direction and the first wall.

### CROSS-REFERENCE TO RELATED APPLICATIONS

This application is based upon and claims the benefit of priority from Japanese Patent Application No. 2025-078687, filed on May 9, 2025, the entire contents of which are incorporated herein by reference.

### BACKGROUND

### Field

The present disclosure relates to an air-conditioning register that discharges conditioned air delivered from an air-conditioning device into an interior space.

### Description of Related Art

JP2025-12824A discloses an airflow direction adjustment device as an example of an air-conditioning register. The airflow direction adjustment device includes, as an inner member, a cylindrical rotating body that is disposed inside a tubular case body. The space between the case body and the rotating body has a passage for conditioned air. The downstream end of the air passage has an air outlet.

Of two directions that are orthogonal to the direction in which the air passage extends and orthogonal to each other, one direction is defined as an axial direction and the other direction is defined as an axis-orthogonal direction.

The case body includes two walls facing each other in the axial direction. The rotating body includes a shaft rotatably supported by the two walls. The case body includes two body passage portions that form part of the passage. The two body passage portions are located on the opposite sides of the rotating body in the axis-orthogonal direction, respectively. The downstream ends of the two body passage portions are each connected to the air outlet.

The case body includes an upstream passage portion located upstream of each of the two body passage portions and the rotating body. The two body passage portions branch from the upstream passage portion. The rotating body is connected to a fin that is located upstream of the rotating body at a branching portion of the two body passage portions. The fin is supported on the two walls by a shaft.

In the above airflow direction adjustment device, rotation of the rotating body causes the fin to close one of the body passage portions, such that the conditioned air flowing through the other body passage portion is discharged obliquely from the air outlet. Rotation of the rotating body also allows the two body passage portions to be opened, such that the conditioned air flowing through both body passage portions meet.

However, in the airflow direction adjustment device disclosed in the above publication, the cross-sectional flow area of the passage is reduced by the rotating body (i.e., an inner member). This increases airflow resistance. As a result, an increase in pressure loss and generation of noise may cause a degradation in air-conditioning performance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An air-conditioning register according to an aspect of the present disclosure includes a case body having a tubular shape, an inner member disposed inside the case body, a passage for conditioned air provided between the case body and the inner member, and an air outlet provided at a downstream end of the passage. The case body includes a first wall and a second wall facing each other. Of the case body, the inner member is in contact with only the second wall. The inner member protrudes from the second wall toward the first wall. When a direction orthogonal to both a direction in which the passage extends and a protruding direction of the inner member is defined as an orthogonal direction, two body passage portions forming part of the passage are provided on opposite sides of the inner member in the orthogonal direction in the case body, respectively, and a connecting passage portion that forms part of the passage and connects the two body passage portions to each other is provided between a protruding end surface of the inner member in the protruding direction and the first wall.

Other features and aspects will be apparent from the following detailed description, the drawings, and the claims.

### BRIEF DESCRIPTION OF THE DRAWINGS

FIG. 1 is a perspective view of an air-conditioning register according to an embodiment.

FIG. 2 is a perspective view showing some components extracted from the air-conditioning register of FIG. 1.

FIG. 3 is a front view of the air-conditioning register in the embodiment.

FIG. 4 is a front view showing a state in which some components are extracted from the air-conditioning register of FIG. 3.

FIG. 5 is a side sectional view of the air-conditioning register in the embodiment.

FIG. 6 is a plan sectional view of the air-conditioning register in the embodiment.

FIG. 7 is a partial side view of the air-conditioning register in the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An air-conditioning register for a vehicle according to an embodiment of the present disclosure will now be described with reference to the drawings.

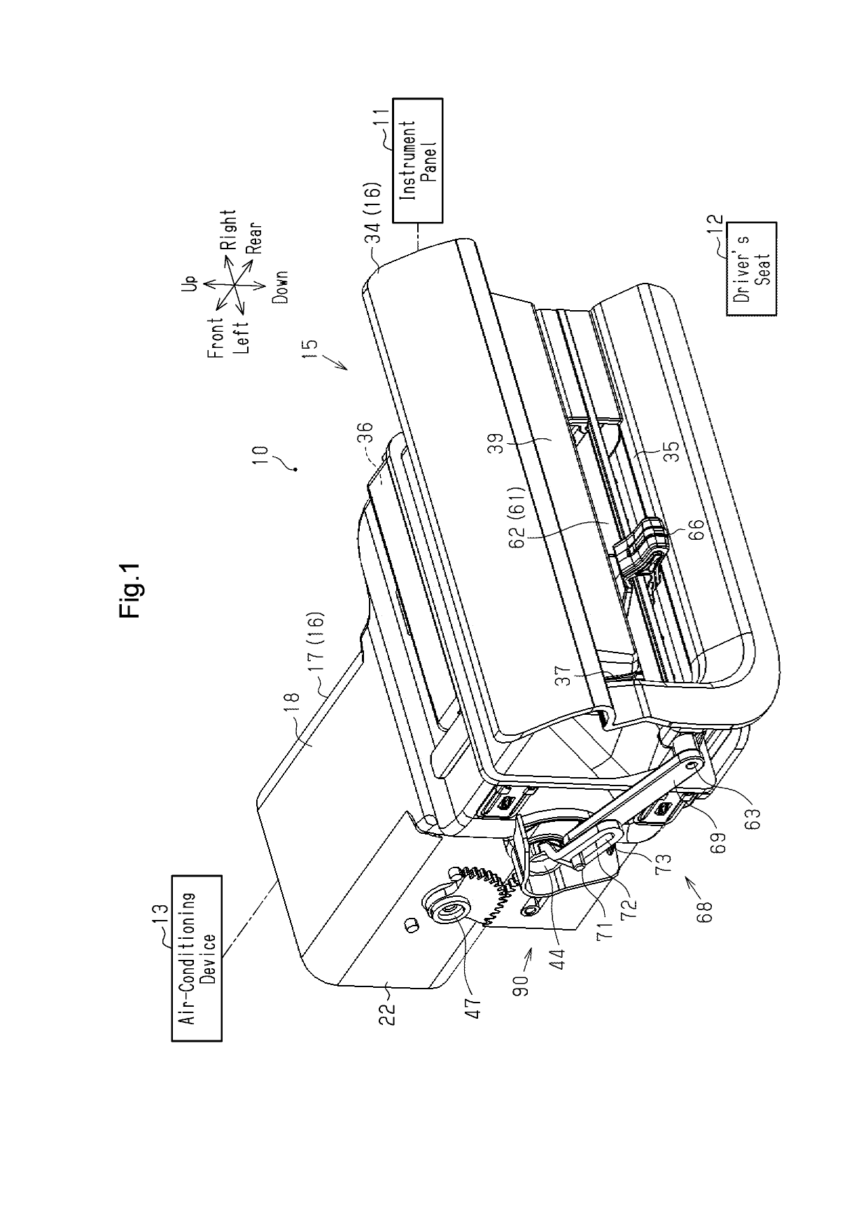

As shown in FIG. 1, an instrument panel 11 is provided in a vehicle interior of a vehicle 10 in front of a front seat. An air-conditioning register 15 is incorporated in, for example, a central portion or a side portion of the instrument panel 11 in a vehicle width direction (a left-right direction). In the present embodiment, the air-conditioning register 15 is incorporated in front of a driver’s seat 12 of a left-hand-drive vehicle.

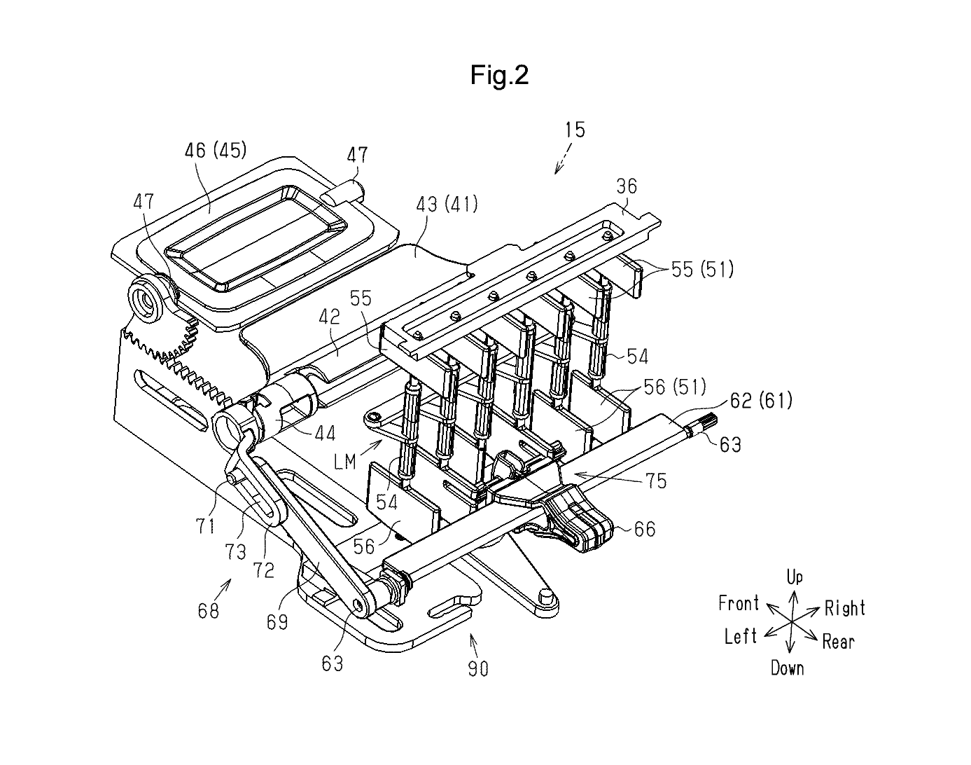

As shown in FIGS. 1 and 2, the air-conditioning register 15 includes a retainer 16, an inner member 37, a distribution member 41, a shut damper 45, two shims 36, upstream fins 51, a downstream fin 61, an operation knob 66, a linkage mechanism 68, a drive mechanism 75, and a transmission mechanism 90. Each component of the air-conditioning register 15 will now be described in detail.

### Retainer 16 and Inner Member 37

Referring to FIG. 1, the retainer 16 connects a ventilation duct (not shown) of the air-conditioning device 13 to an opening (not shown) provided in the instrument panel 11. The retainer 16 includes a retainer body 17 and a bezel 34. The retainer body 17 is an example of a case body.

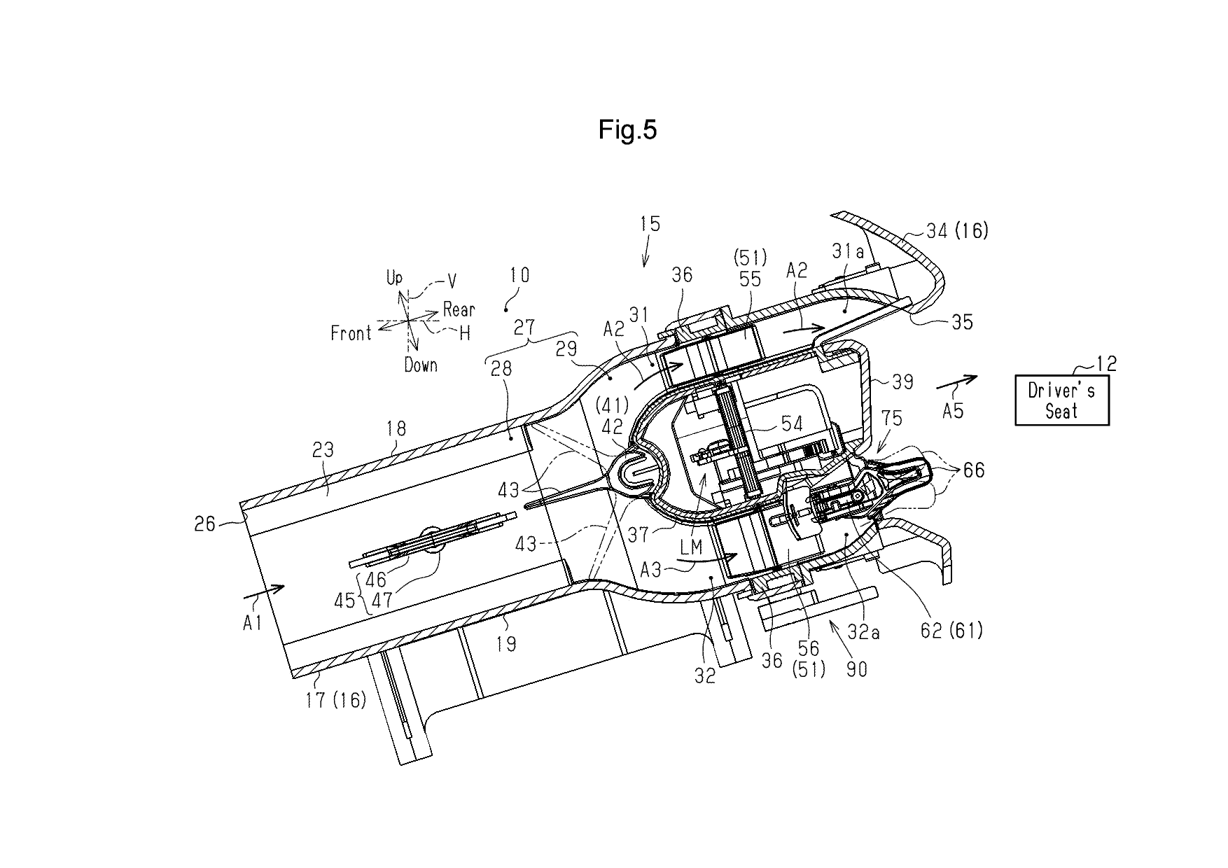

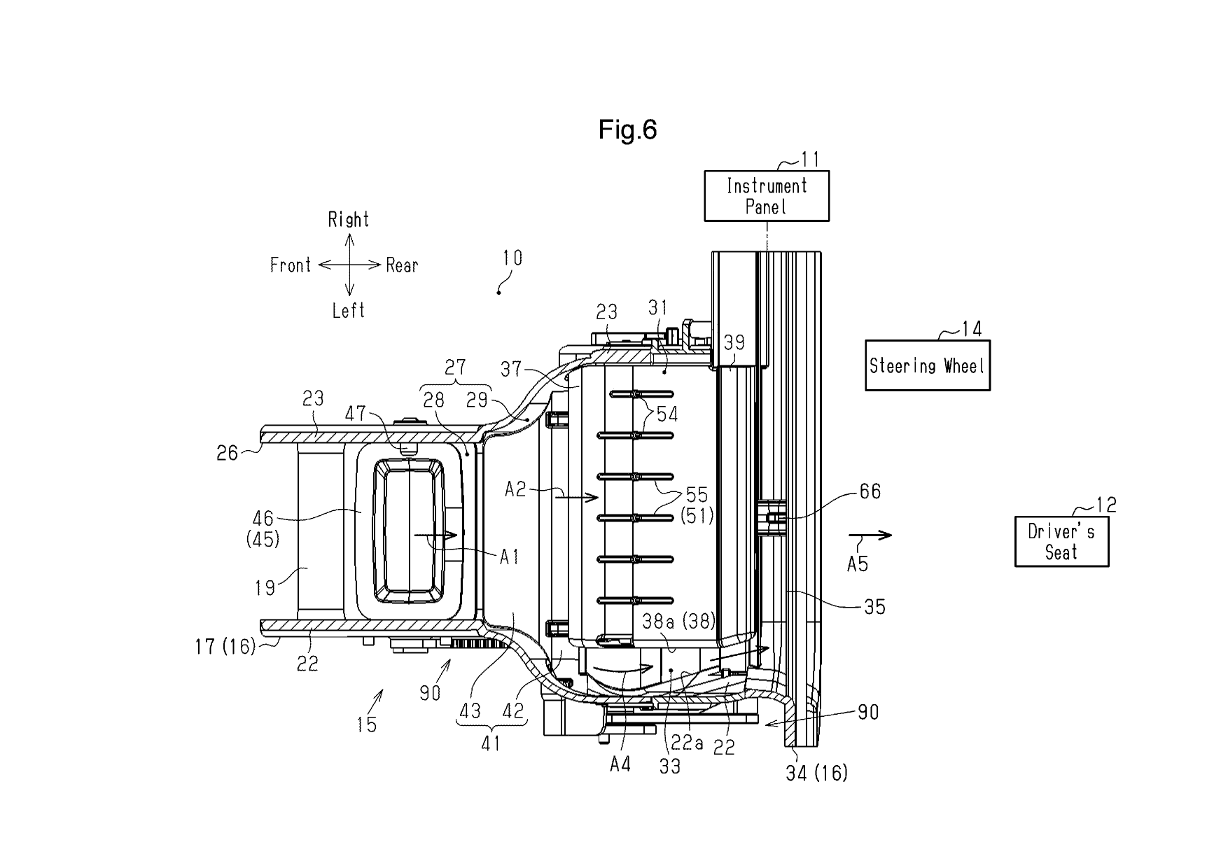

As shown in FIGS. 5 and 6, the retainer body 17 has a passage 27 for conditioned air A1 to A4. The passage 27 is inclined with respect to a horizontal plane H, rising toward the rear of the vehicle 10. In the present specification, the passage 27 serves as a reference for describing components of the air-conditioning register 15. The direction in which the passage 27 extends is referred to as a front-rear direction. Two directions that are orthogonal to the front-rear direction and orthogonal to each other are defined such that one direction is an up-down direction and the other direction is a left-right direction. The up-down direction of the air-conditioning register 15 is slightly inclined with respect to a vertical plane V.

The conditioned air A1 to A4 flows through the passage 27 from the front (upstream) toward the rear (downstream). The retainer body 17 has a tubular shape, with its upstream and downstream ends being open. The upstream end of the retainer body 17 serves as an inlet 26 for the conditioned air A1.

The bezel 34 forms a most downstream portion of the retainer 16, and is attached to the retainer body 17. The bezel 34 has an air outlet 35 at a portion corresponding to a downstream end of the passage 27, from which the conditioned air A2 to A4 is discharged. A portion of the bezel 34 surrounding the air outlet 35 forms part of a design surface of the air-conditioning register 15.

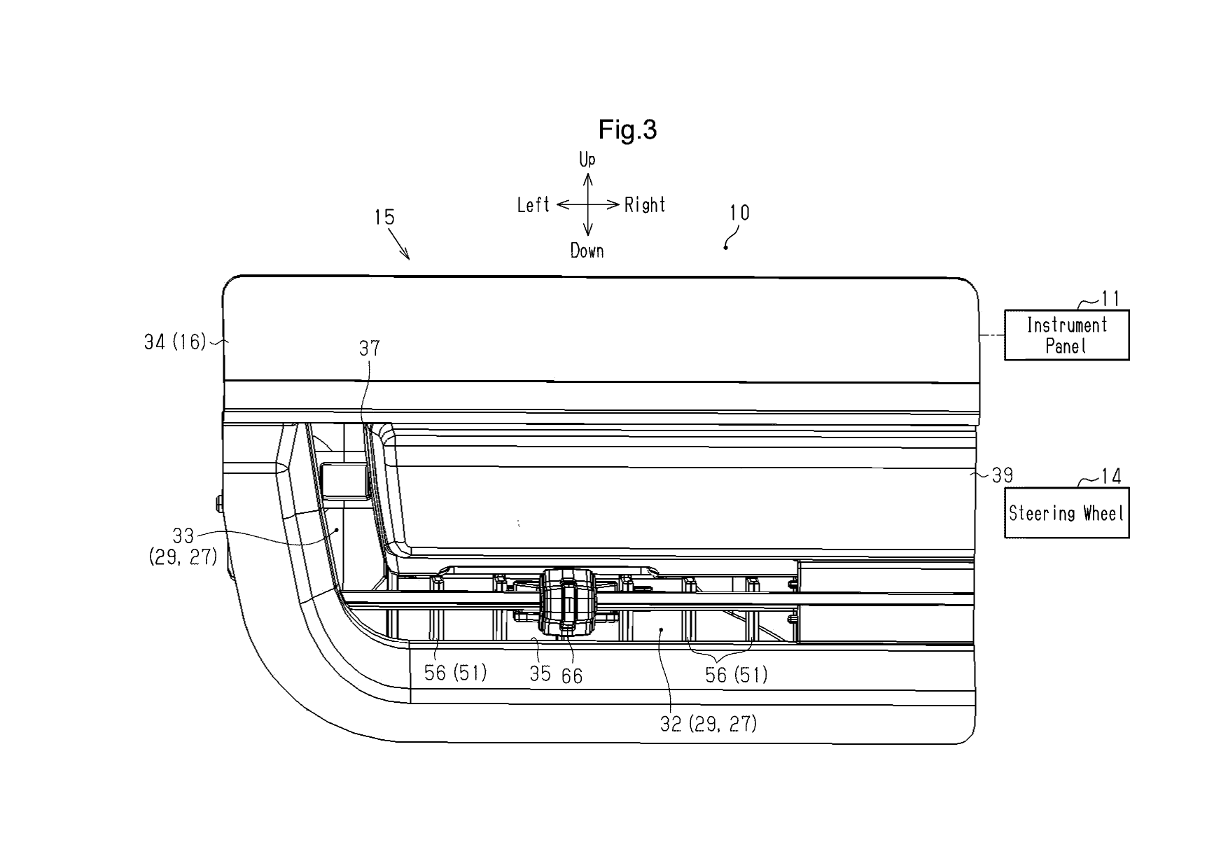

As shown in FIGS. 3 - 6, the passage 27 includes an upstream passage portion 28 and a downstream passage portion 29, which is connected to the upstream passage portion 28 on its downstream side. The downstream passage portion 29 includes two body passage portions 31, 32 and a connecting passage portion 33.

The retainer body 17 includes an upper wall 18 and a lower wall 19 facing each other in the up-down direction, and two side walls 22, 23 facing each other in the left-right direction. The upper wall 18, the lower wall 19, and the two side walls 22 and 23 each have straight portions extending along the passage 27 at upstream and downstream portions thereof. The left side wall 22 is an example of a first wall. The right side wall 23 is an example of a second wall. The right side wall 23 is located in front of the steering wheel 14 mounted on the instrument panel 11 in the vehicle 10. The steering wheel 14 is an example of a functional component.

In describing components of the air-conditioning register 15, a direction in the thickness direction of the retainer body 17 away from the passage 27 may be referred to as terms such as “outward” or “outside.”

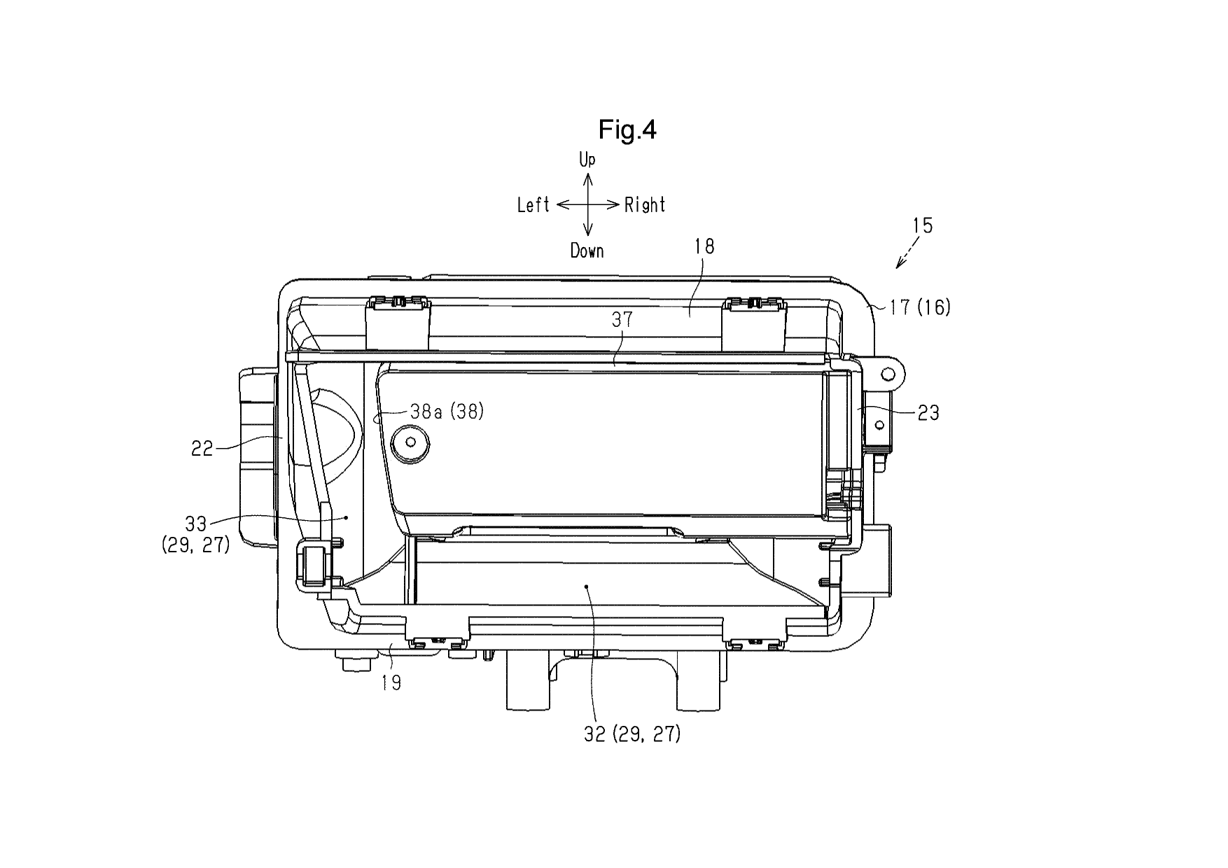

As shown in FIGS. 4 - 6, the inner member 37 is located downstream of the upstream passage portion 28 in the retainer body 17. Of the retainer body 17, the inner member 37 is in contact with only the side wall 23. The inner member 37 protrudes from the side wall 23 toward the side wall 22. Accordingly, the protruding direction of the inner member 37 extends from the side wall 23 toward the side wall 22.

The up-down direction of the air-conditioning register 15 is orthogonal to both the direction in which the passage 27 extends (the front-rear direction) and the protruding direction of the inner member 37. The up-down direction of the air-conditioning register 15 may be hereinafter referred to an orthogonal direction.

The basal (right) end of the inner member 37 is attached to the right side wall 23. The inner member 37 includes a protruding end surface 38 having a flat portion 38a that extends in the front-rear direction. The protruding end surface 38 is spaced apart from the left side wall 22 rightward.

As shown in FIGS. 3, 5, and 6, a decorative panel 39 extending in the left-right direction is disposed downstream of the inner member 37 and downstream of the right side wall 23. The decorative panel 39 is attached to each of the inner member 37 and the right side wall 23. The decorative panel 39 has a downstream end surface that forms part of the design surface of the air-conditioning register 15.

The decorative panel 39 may include a base formed of, for example, a resin material, and a decorative film attached to a downstream end surface of the base. Alternatively, instead of the decorative film, a thin natural wood plate may be attached to the downstream end surface of the base.

As shown in FIGS. 4 - 6, the downstream passage portion 29 is located between the retainer body 17 and the inner member 37. The retainer body 17 includes the two body passage portions 31, 32 on opposite sides of the inner member 37 in the up-down direction. The body passage portion 31 is located between the inner member 37 and the upper wall 18. The body passage portion 32 is located between the inner member 37 and the lower wall 19.

The connecting passage portion 33 is located between the protruding end surface 38 of the inner member 37 and the left side wall 22. The connecting passage portion 33 connects the two body passage portions 31, 32 to each other. The connecting passage portion 33 is not provided between the inner member 37 and the right side wall 23 (second wall). The two body passage portions 31, 32 and the connecting passage portion 33 lead to the air outlet 35. The two body passage portions 31, 32 and the connecting passage portion 33 branch, on the upstream side of the inner member 37, from the upstream passage portion 28.

The conditioned air A2 flowing through the upper body passage portion 31, the conditioned air A3 flowing through the lower body passage portion 32, and the conditioned air A4 flowing through the connecting passage portion 33 are discharged from the air outlet 35.

The retainer 16 is configured such that the conditioned air A2 and the conditioned air A3 meet. That is, the downstream portions 31a, 32a of the two body passage portions 31, 32 are inclined with respect to the extending direction of the passage 27 (i.e., the front-rear direction) such that the downstream portions 31a, 32a approach each other toward the air outlet 35.

The inner wall surface of the left side wall 22 has an inclined surface 22a that is inclined with respect to the flat portion 38a such that the inclined surface 22a becomes closer to the flat portion 38a toward the downstream side. The angle of the inclined surface 22a with respect to the flat portion 38a is, for example, approximately 10° to 15°, but is not limited thereto.

### Distribution Member 41

As shown in FIGS. 2, 5, and 6, the distribution member 41 is disposed inside the retainer body 17 in the region where the two body passage portions 31 and 32 branch, adjacent to the inner member 37 on the upstream side. The distribution member 41 includes a rotating base 42 extending in the left-right direction and a flat distribution body 43 radially protruding outward from the rotating base 42. Distribution shafts 44 are provided on the opposite sides of the rotating base 42 in the left-right direction, respectively. The distribution member 41 is supported by the two distribution shafts 44 to be vertically tiltable with respect to the side walls 22, 23.

The distribution member 41 tilts to distribute some of the conditioned air A1 flowing through the upstream passage portion 28 to the two body passage portions 31, 32. In other words, the distribution member 41 changes the ratio between the conditioned air A2, which flows through the upper body passage portion 31, and the conditioned air A3, which flows through the lower body passage portion 32.

### Shut Damper 45

The shut damper 45 includes a flat damper body 46 disposed in the upstream passage portion 28. The shut damper 45 also includes two damper shafts 47 provided at the opposite side edges of the damper body 46 in the left-right direction. The shut damper 45 is supported on the side walls 22, 23 by the two damper shafts 47 so as to be tiltable between an open position and a closed position.

In the open position, as indicated by solid lines in FIG. 5, the damper body 46 is parallel or substantially parallel to the upstream portions of the upper wall 18 and the lower wall 19, and creates a relatively large opening to the upstream passage portion 28. In the closed position, although not illustrated, the damper body 46 tilts while being substantially orthogonal to the upstream portions of the upper wall 18 and the lower wall 19, and closes the upstream passage portion 28.

### Shim 36

As shown in FIGS. 2 and 5, the air-conditioning register 15 includes two flat shims 36. The upper shim 36 is attached to the upper wall 18. The lower shim 36 is attached to the lower wall 19. In FIG. 2, the lower shim 36 is not shown.

### Upstream Fins

Each upstream fin 51 includes an upstream fin shaft 54 extending in the up-down direction, unlike the damper shaft 47 extending in the left-right direction. The upstream fin shafts 54 are spaced apart from each other in the left-right direction. An intermediate portion of each upstream fin shaft 54 in the up-down direction is inserted through the inner member 37. The upper end of each upstream fin shaft 54 is rotatably supported by the upper shim 36. The lower end of each upstream fin shaft 54 is rotatably supported by the lower shim 36.

Each upstream fin shaft 54 includes a flat upper upstream fin body 55 at a portion between the upper wall 18 and the inner member 37. The upstream fin shaft 54 and the upper upstream fin body 55 are integrally rotatable. Each upstream fin shaft 54 includes a flat lower upstream fin body 56 at a portion between the lower wall 19 and the inner member 37. The upstream fin shaft 54 and the upper upstream fin body 56 are integrally rotatable.

The upstream fins 51 are all connected by the link mechanism LM. The link mechanism LM tilts all of the upstream fins 51 synchronously such that they are inclined in the same direction.

The upstream fins 51 having the above configuration change the discharge direction of the conditioned air A1, A2 from the air outlet 35 to the left-right direction, by tilting in the left-right direction about the upstream fin shaft 54. In addition, the upstream fins 51 are configured to close the two body passage portions 31, 32 to prevent the conditioned air A1, A2 from flowing downstream of the upstream fin bodies 55, 56 in the body passage portions 31, 32.

### Downstream Fin 61

As shown in FIGS. 2 and 5, the downstream fin 61 includes a flat downstream fin body 62 and two downstream fin shafts 63 provided on the opposite side edges of the downstream fin body 62 in the left-right direction. The downstream fin 61 is supported on the side walls 22, 23 by the two downstream fin shafts 63 so as to be vertically tiltable. The downstream fin 61 changes the flow direction of the conditioned air A2 in the up-down direction in the lower body passage portion 32, by vertically tilting about the downstream fin shafts 63.

### Operation Knob 66

The operation knob 66 is operated by a vehicle occupant to, for example, change the discharge direction of the conditioned air A5 from the air outlet 35 or block discharge of the conditioned air A5 from the air outlet 35. In other words, the operation knob 66 is operated to tilt the upstream fins 51 and tilt the downstream fin 61. The operation knob 66 is attached to the downstream fin body 62 to be slidable in the left-right direction. As shown by the double-dashed line in FIG. 5, the operation knob 66 is vertically tiltable together with the downstream fin 61 about the two downstream fin shafts 63.

### Linkage Mechanism 68

As shown in FIGS. 1, 2, and 7, the linkage mechanism 68 tilts the distribution member 41 in conjunction with tilting of the downstream fin 61 by transmitting rotation of the downstream fin shaft 63 to the distribution member 41. The linkage mechanism 68 is located between the downstream fin shafts 63 and the distribution shaft 44. The linkage refers to tilting, when the downstream fin 61 is vertically tilted, the distribution member 41 in a direction opposite to the tilting direction of the downstream fin 61.

A drive lever 69 is attached to the left downstream fin shaft 63, which protrudes from the left side wall 22, so as to be integrally rotatable. The drive lever 69 extends radially outward from that downstream fin shaft 63. A pin 71 that protrudes outward in the left-right direction is fixed to a protruding end of the drive lever 69.

A driven lever 72 is attached to the left distribution shaft 44, which protrudes from the left side wall 22, so as to be integrally rotatable. The driven lever 72 extends radially outward from the distribution shaft 44. The driven lever 72 is disposed outside the drive lever 69 in the left-right direction. The driven lever 72 has an elongated hole 73 radially extending in the distribution shaft 44. By engagement of the pin 71 with the elongated hole 73, the drive lever 69 and the driven lever 72 are coupled to each other to transmit power.

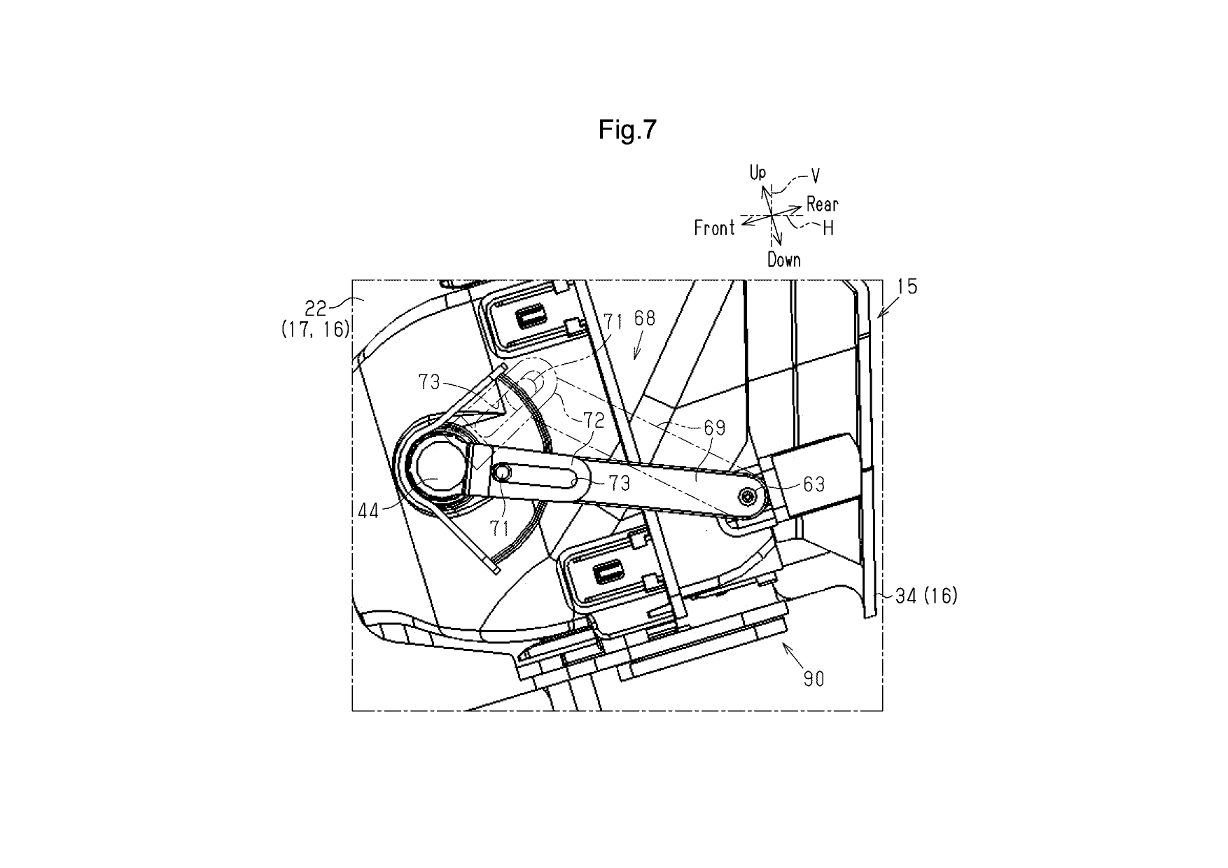

As shown by the solid line and the double-dashed line in FIG. 7, when the drive lever 69 tilts as the downstream fin shaft 63 rotates, the linkage mechanism 68 transmits the tilting to the driven lever 72 via the pin 71 and the elongated hole 73. Further, the driven lever 72 is tilted in a direction opposite to the drive lever 69. Then, in accordance with the tilting, the distribution shaft 44 is rotated in a direction opposite to the downstream fin shaft 63. As a result, the distribution body 43 is tilted.

### Drive Mechanism 75

As shown in FIGS. 2 and 5, the drive mechanism 75 tilts the upstream fins 51 in conjunction with sliding of the operation knob 66 in the left-right direction. The drive mechanism 75 includes components provided between the operation knob 66 and the upstream fins 51.

### Transmission Mechanism 90

The transmission mechanism 90 transmits tilting of the upstream fins 51 to the shut damper 45. The transmission mechanism 90 includes components provided between the upstream fins 51 and the shut damper 45.

### OPERATION OF THE PRESENT EMBODIMENT

### Operation Knob 66 at Reference Position

FIGS. 2 and 6 each show a state of the air-conditioning register 15 when the operation knob 66 is positioned at the center of a range of left-right movement and at the center of a range of up-down movement. The position of the operation knob 66 in this state is referred to as a reference position.

The shut damper 45 is in the open position. In the open position, as shown in FIG. 5, the damper body 46 is parallel or substantially parallel to the upstream portions of the upper wall 18 and the lower wall 19, and thus creates a relatively large opening to the upstream passage portion 28 in the up-down direction.

When the distribution body 43 is parallel or substantially parallel to the upstream portions of the upper wall 18 and the lower wall 19, a relatively large opening is created to each of the body passage portions 31, 32.

As shown in FIGS. 5 and 6, the upstream fins 51 are all parallel or substantially parallel to the downstream portion of the side walls 22, 23. The upper upstream fin bodies 55 create a relatively large opening to the upper body passage portion 31, and the lower upstream fin bodies 56 create a relatively large opening to the lower body passage portion 32. The position of each upstream fin 51 in this state is referred to as a neutral position.

The downstream fin body 62 is parallel or substantially parallel to the downstream portions of the upper wall 18 and the lower wall 19. The downstream fin body 62 creates a relatively large opening to the lower body passage portion 32. The position of the downstream fin 61 in this state is referred to as a neutral position.

The conditioned air A1 that has flowed into the retainer 16 from the inlet 26 is distributed to the upper and lower sides of the shut damper 45 and the distribution body 43 when passing through the shut damper 45 and the distribution body 43. The conditioned air A2 distributed to the upper body passage portion 31 flows downstream along the upstream fin body 55. Similarly, the conditioned air A3 distributed to the lower body passage portion 32 flows downstream along the upstream fin body 56.

As the conditioned air A2 flows through the downstream portion 31a of the body passage portion 31, the flow direction gradually shifts downward toward the downstream side. As the conditioned air A3 flows through the downstream portion 32a of the body passage portion 32, the flow direction gradually shifts upward toward the downstream side.

Further, the conditioned air A4 that has flowed into the connecting passage portion 33 flows along the inclined surface 22a, so that the flow direction is changed rightward (i.e., toward the inner member 37). The conditioned air A4 flows toward the inner member 37 and consequently toward the occupant (the driver in this case), as compared to when the inclined surface 22a is not provided on the side wall 22.

The conditioned air A2 that has flowed through the upper body passage portion 31, the conditioned air A3 that has flowed through the lower body passage portion 32, and the conditioned air A4 that has flowed through the connecting passage portion 33 meet and merge to form a single downstream flow of conditioned air A5.

The operation of the air-conditioning register 15 when the operation knob 66 is manipulated to change the discharge direction of the conditioned air A5 from the air outlet 35 will now be described.

### Application of Up-Down Directional Force to the Operation Knob 66

Referring to FIGS. 2, 5, and 7, when an up-down directional force is applied to the operation knob 66 located at the reference position, this force is transmitted to the downstream fin 61. The downstream fin 61 at the neutral position is tilted about the two downstream fin shafts 63. The tilting is transmitted to the distribution member 41 via the linkage mechanism 68. In conjunction with the tilting of the downstream fin 61, the distribution body 43 vertically tilts about the rotating base 42.

The distribution member 41 changes the ratio between the conditioned air A2, which flows into the upper body passage portion 31 from the upstream passage portion 28, and the conditioned air A3, which flows into the lower body passage portion 32 from the upstream passage portion 28.

For example, when an upward force is applied to the operation knob 66, the downstream fin body 62 tilts so as to become higher toward the downstream side. The tilting is transmitted to the distribution member 41 via the linkage mechanism 68, so that the distribution body 43 tilts in a direction opposite to the downstream fin body 62.

When the distribution body 43 is tilted so as to become higher toward the upstream side, the flow of the conditioned air A1 from the upstream passage portion 28 into the upper body passage portion 31 is restricted by the distribution member 41. Accordingly, a smaller amount of the conditioned air A1 flows into the upper body passage portion 31, and a larger amount of the conditioned air A1 flows into the lower body passage portion 32.

The conditioned air A3 flows along the tilted downstream fin 61 while flowing through the lower body passage portion 32, so that the flow direction becomes higher toward the downstream side and changes to a direction corresponding to the tilting of the upstream fin body 55.

The amount of the conditioned air A2 flowing through the lower body passage portion 32 is larger than the amount of the conditioned air A3 flowing through the upper body passage portion 31. Thus, the flow direction after the conditioned air A2 and the conditioned air A3 meet is tilted so as to be higher toward the downstream side.

When the distribution body 43 tilts so as to become higher toward the upstream side contacts or closely approaches the upper wall 18, the upper body passage portion 31 closes. The conditioned air A1 flowing through the upstream passage portion 28 is restricted from flowing into the upper body passage portion 31. As a result, the conditioned air A1 flows into the lower body passage portion 32 and the connecting passage portion 33.

### Application of Left-Right Directional Force to the Operation Knob 66

When the operation knob 66 is slid from the reference position toward one side in the left-right direction (e.g., leftward), the sliding is transmitted to the two upstream fins 51 located at the neutral position by the drive mechanism 75. Accordingly, all of the upstream fins 51 are synchronously tilted by the same angle about their respective upstream fin shafts 54. The conditioned air A2, A3 flows downstream along the upstream fin bodies 55 and 56. The conditioned air A2, A3 is thereby directed obliquely leftward and discharged from the air outlet 35.

When the operation knob 66 is slid further leftward from the above state, each of the upstream fins 51 tilts further in a direction that closes the body passage portions 31, 32. During the sliding, the tilting of the upstream fins 51 is transmitted to the shut damper 45 by the transmission mechanism 90.

The shut damper 45 tilts about the damper shaft 47 in the direction that closes the upstream passage portion 28. This reduces the amount of the conditioned air A1 flowing downstream of the damper body 46 in the passage 27.

By the sliding of the operation knob 66, the upper body passage portion 31 is closed by the upper upstream fin bodies 55, and the lower body passage portion 32 is closed by the lower upstream fin bodies 56. Further, the upstream passage portion 28 is closed by the damper body 46. The passage 27 is closed by the shut damper 45 and the upstream fins 51. This prevents the conditioned air A1 from flowing downstream of the damper body 46 in the passage 27. The conditioned air A4 no longer flows through the connecting passage portion 33.

When the operation knob 66 is slid rightward from the above state, the components operate in a manner opposite to that described above.

### IMPROVEMENT IN AIR-CONDITIONING PERFORMANCE

The downstream passage portion 29 of the passage 27 is formed by the connecting passage portion 33 in addition to the two body passage portions 31, 32. The cross-sectional flow area of the downstream passage portion 29 is increased by the connecting passage portion 33. Accordingly, ventilation resistance decreases.

Formation of the Connecting Passage Portion 33 Only on One Side of the Inner Member 37

The connecting passage portion 33 is not provided between the inner member 37 and the side wall 23. Accordingly, the conditioned air A4 does not flow downstream through the space between the inner member 37 and the side wall 23. Thus, the conditioned air A5 does not reach the occupant. However, such a configuration is unlikely to be problematic.

This is because the steering wheel 14 is located behind the side wall 23, as shown in FIGS. 3 and 6. In other words, this is because, even if the connecting passage portion 33 is provided between the inner member 37 and the side wall 23, the conditioned air A4 would flow through the connecting passage portion 33 and then the conditioned air A5 would strike the steering wheel 14, so that the conditioned air A1 is less likely to reach the occupant. Even if the connecting passage portion 33 is provided between the inner member 37 and the side wall 23, the amount of the conditioned air A5 reaching the occupant is not significantly increased as compared to a configuration without the connecting passage portion 33. Thus, as described above, even a configuration in which the connecting passage portion 33 is not provided between the inner member 37 and the side wall 23 is unlikely to be problematic.

### ADVANTAGES OF THE PRESENT EMBODIMENT

(1) As shown in FIGS. 5 and 6, the retainer body 17 includes the two body passage portions 31, 32, which form part of the passage 27. The two body passage portions 31, 32 are respectively provided on the opposite sides of the inner member 37 in the up-down direction. The connecting passage portion 33, which forms part of the passage 27 and connects the two body passage portions 31, 32 to each other, is provided between the protruding end surface 38 of the inner member 37 and the side wall 22.
Accordingly, the cross-sectional flow area of the downstream passage portion 29 is increased by the connecting passage portion 33. With the inner member 37 disposed in the retainer body 17, an increase in pressure loss and generation of noise are limited. As a result, air-conditioning performance is improved.
(2) The inner wall surface of the side wall 22 has the inclined surface 22a, which is inclined with respect to the flat portion 38a of the protruding end surface 38, such that the inclined surface 22a becomes closer to the flat portion 38a toward the downstream side.
This allows the conditioned air A4 to flow toward the inner member 37 and consequently toward the occupant (i.e., the driver), as compared to when the inclined surface 22a is not provided on the side wall 22.
(3) The downstream ends of the two body passage portions 31, 32 and the connecting passage portion 33 are connected to the air outlet 35. The downstream portions 31a, 32a of the two body passage portions 31, 32 are inclined with respect to the extending direction of the passage 27 (i.e., the front-rear direction) such that the downstream portions 31a, 32a approach each other toward the air outlet 35.
Thus, the conditioned air A2, A3 that has flowed through the body passage portion 31, 32 and the conditioned air A4 that has flowed through the connecting passage portion 33 meet and merge to form a single downstream flow of conditioned air A5.
(4) The retainer body 17 includes the upstream passage portion 28 on the upstream side of each of the two body passage portions 31, 32 and the inner member 37. The two body passage portions 31, 32 and the connecting passage portion 33 branch, on the upstream side of the inner member 37, from the upstream passage portion 28. The distribution member 41, which distributes part of the conditioned air A1 flowing through the upstream passage portion 28 to the two body passage portions 31, 32, is disposed inside the retainer body 17 and at the branching portion of the two body passage portions 31, 32.
This configuration allows the ratio between the conditioned air A2, which flows into the upper body passage portion 31 from the upstream passage portion 28, and the conditioned air A3, which flows into the lower body passage portion 32, to be changed so that the up-down direction of the conditioned air A5 discharged from the air outlet 35 is changed.
(5) As shown in FIGS. 3 and 4, in the present embodiment, the connecting passage portion 33 is not provided between the side wall 23, which is positioned in front of the steering wheel 14 and the inner member 37.
However, because the effect on the amount of conditioned air reaching the occupant is negligible, such a configuration is unlikely to be problematic.
(6) The flow direction of the conditioned air A4 flowing through the connecting passage portion 33 in the left-right direction may be changed by providing upstream fins on the connecting passage portion 33 instead of the inclined surface 22a. However, in this case, the upstream fins of the connecting passage portion 33 may be visible from the downstream side of the air-conditioning register 15, resulting in an undesirable appearance. In addition, an additional mechanism for tilting the upstream fins in the connecting passage portion 33 is required.
In the present embodiment, the direction of the conditioned air A4 in the left-right direction is changed by providing the inclined surface 22a on the inner wall surface of the side wall 22. The inclined surface 22a is used to do part of what upstream fins would otherwise do. Thus, no upstream fins are provided in the connecting passage portion 33.
Accordingly, no upstream fins of the connecting passage portion 33 are visible from the downstream side of the air-conditioning register 15. Thus, as compared to when upstream fins are visible, the appearance is improved. This improves the appearance while maintaining the air-conditioning capability for changing the flow direction of the conditioned air A4. In addition, such a configuration eliminates the need for an additional mechanism for tilting the upstream fins in the connecting passage portion 33.
(7) As shown in FIG. 5, the downstream portion 31a of the body passage portion 31 is inclined with respect to the direction in which the passage 27 extends (i.e., the front-rear direction), such that the downstream portion 31a approaches the downstream portion 32a of the body passage portion 32 toward the air outlet 35. In other words, the downstream portion 31a becomes lower toward the air outlet 35.
Accordingly, when the occupant views the air-conditioning register 15 obliquely from the rear upper side, the upper upstream fin body 55 is hidden by the upper wall 18 and the bezel 34. Since the upper upstream fin body 55 is difficult to see, the appearance of the air-conditioning register 15 is improved.

### MODIFICATIONS

The present embodiment may be modified as follows. The present embodiment and the following modifications can be combined as long as the combined modifications remain technically consistent with each other.

The downstream portions 31a, 32a of the two body passage portions 31, 32 do not have to be inclined with respect to the extending direction of the passage 27 (i.e., the front-rear direction) such that the downstream portions 31a, 32a approach each other toward the air outlet 35.

Instead of being provided separately from the retainer body 17 as in the above embodiment, the inner member 37 may be integrated with the right side wall 23.

The inner member 37 may be attached to a separate component arranged outside the retainer 16. However, even in this case, the inner member 37 is attached to the separate component while being in contact with the right side wall 23.

The protruding end surface 38 of the inner member 37 may be curved. Even in this case, it is preferred that the inner wall surface of the first wall (i.e., the left side wall 22) be inclined such that the portion of the first wall closer to the air outlet 35 is positioned inward in the left-right direction.

The inclined surface 22a may be omitted from the inner wall surface of the left side wall 22. For example, the inner wall surface may be parallel to the flat portion 38a. In this case, the connecting passage portion 33 may include an additional upstream fin that changes the flow direction of the conditioned air A4 in the left-right direction.

The present disclosure may be applied to an air-conditioning register 15 incorporated in front of the passenger seat in the instrument panel 11. This provides the following advantage.

In recent years, an elongated decorative panel extending to or beyond the vicinity of its central portion in the left-right direction has been incorporated in the instrument panel 11. Accordingly, the decorative panel 39 of the air-conditioning register 15 may be part of the elongated decorative panel. Further, the decorative panel 39 of the air-conditioning register 15 may extend beyond the second wall (i.e., the side wall 23) of the retainer body 17 to form the entire elongated decorative panel. In this case, in the same manner as the decorative panel 39, the bezel 34 may extend beyond the second wall of the retainer body 17. Based on these modifications, the overall design of the elongated decorative panel remains undisturbed by the air-conditioning register 15.

When the present disclosure is applied to the air-conditioning register 15 incorporated in front of the passenger seat in the instrument panel 11 as described above, a functional component such as a display may be disposed behind the second wall. In this case, in the same manner as the above embodiment, the connecting passage portion 33 is not provided between the inner member 37 and the second wall. The conditioned air A4 does not reach the occupant after passing through the space between the inner member 37 and the second wall. However, such a configuration is unlikely to be problematic.

This is because, even if the connecting passage portion 33 is provided between the inner member 37 and the second wall, the conditioned air A4 would flow through the connecting passage portion 33 and then strike the rear surface of the display, so that the conditioned air A5 is less likely to reach the occupant. That is, as compared to a configuration without the connecting passage portion 33, the amount of the conditioned air A5 reaching the occupant is not significantly increased even if the connecting passage portion 33 is provided between the inner member 37 and the second wall. Thus, as described above, even a configuration in which the connecting passage portion 33 is not provided between the inner member 37 and the second wall is unlikely to be problematic.

The air-conditioning register 15 may be incorporated in a location in the vehicle interior other than the instrument panel 11, such as a dashboard.

The present disclosure is also applicable to an air-conditioning register 15 incorporated in an instrument panel 11 of a right-hand-drive vehicle. In this case, the positional relationship between the first and second walls in the left-right direction is opposite to that in the above embodiment. For example, in the air-conditioning register 15 incorporated in front of the driver’s seat 12, the right side wall 23 is an example of the first wall, and the left side wall 22 is an example of the second wall.

The air-conditioning register 15 is widely applicable not only to vehicles but also to other applications, as long as the passage 27 of the retainer body 17 includes the connecting passage portion 33 in addition to the two body passage portions 31, 32.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An air-conditioning register, comprising:
a case body having a tubular shape;
an inner member disposed inside the case body;
a passage for conditioned air provided between the case body and the inner member; and
an air outlet provided at a downstream end of the passage, wherein
the case body includes a first wall and a second wall facing each other,
of the case body, the inner member is in contact with only the second wall,
the inner member protrudes from the second wall toward the first wall, and
when a direction orthogonal to both a direction in which the passage extends and a protruding direction of the inner member is defined as an orthogonal direction,
two body passage portions forming part of the passage are provided on opposite sides of the inner member in the orthogonal direction in the case body, respectively, and
a connecting passage portion that forms part of the passage and connects the two body passage portions to each other is provided between a protruding end surface of the inner member in the protruding direction and the first wall.

2. The air-conditioning register according to claim 1, wherein
the protruding end surface of the inner member includes a flat portion, and
an inner wall surface of the first wall has an inclined surface that is inclined with respect to the flat portion such that the inclined surface becomes closer to the flat portion toward a downstream side of the connecting passage portion.

3. The air-conditioning register according to claim 1, wherein
a downstream end of each of the two body passage portions and the connecting passage portion is connected to the air outlet, and
the two body passage portions include downstream portions that are inclined with respect to the direction in which the passage extends, such that the downstream portions approach each other toward the air outlet.

4. The air-conditioning register according to claim 1, wherein
the case body includes an upstream passage portion on an upstream side of each of the two body passage portions and the inner member,
the two body passage portions and the connecting passage portion branch, on the upstream side of the inner member, from the upstream passage portion, and
a distribution member configured to distribute part of the conditioned air flowing through the upstream passage portion to the two body passage portions is disposed inside the case body and at a branching portion of the two body passage portions.

5. The air-conditioning register according to claim 1, wherein
the air-conditioning register is incorporated in an instrument panel of a vehicle,
the first wall and the second wall face each other in a vehicle width direction, and
the second wall is disposed in front of a functional component that is mounted on the instrument panel in the vehicle.
